(19) United States
(12) Patent Application Publication
(10) Pub. No.: US 2008/0145174 A1
(43) Pub. Date: Jun. 19, 2008

(54) Channel Fastener

(75) Inventors: Shunichi Suzuki, Tokyo (JP); Yoshio Takagi, Tokyo (JP); Yoshiaki Ishii, Tokyo (JP); Akihiro Miyazaki, Tokyo (JP); Tadashi Teramatsu, Tokyo (JP); Akihiko Fujita, Tokyo (JP); Masatake Taguchi, Tokyo (JP); Shingo Yamaguchi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: The Tokyo Electric Power Company, Inc., Chiyoda-ku, Tokyo (JP)

(21) Appl. No.: 11/722,357

(22) PCT Filed: Dec. 20, 2005
(86) PCT No.: PCT/JP2005/023374

§ 371 Date: Feb. 7, 2008

(30) Foreign Application Priority Data
Dec. 21, 2004 (JP) 2004-369822

(51) Int. Cl. F16B 27/00

(52) U.S. Cl. 411/84

(57) ABSTRACT

A channel fastener, which is capable of preventing or suppressing the plastic deformation of a leaf spring when the other device such as a fuel assembly and a tool is brought into contact therewith from the upper side, is provided. The channel fastener (6) comprises a leaf spring guard (9) having a leg body (13) formed in a roughly L-shape in horizontal cross section and extending vertically and a flat upper plate (12) connected to the leg body (13) at the upper end of the leg body (13) and extending horizontally, and a leaf spring (8) having an upper plate part (15) fixed to the leaf spring guard flat upper plate (12) and extending along the leaf spring guard flat upper plate (12) and at least two legs (17) connected to the upper plate part (15) and extending downward along the leaf spring guard leg body (13). One or a plurality of projected parts (21) projected upward are formed on the leaf spring guard fiat upper plate (12).

### TECHNICAL FIELD

The present invention relates to a channel fastener mounted on a fuel assembly in the reactor core of a boiling water reactor, and specifically to a channel fastener capable of preventing the deformation of a leaf spring composing the channel fastener.

### BACKGROUND ART

FIG. 1 is an illustration showing the schematic overview of a fuel assembly loaded in the reactor core of a boiling water reactor. In each grid of an upper grid plate 1 installed in the boiling water reactor, four fuel assemblies 3 are loaded so as to enclose a control rod 2 having a + shaped cross section. The fuel assembly 3 has a configuration in which a plurality of fuel rods are housed in a channel box 4 having a square horizontal section. The bottom end portion of the fuel assembly 3 is supported by a fuel support metal fitting 5, and the neighborhood of the upper end portion of the fuel assembly 3 is constrained horizontally by the upper grid plate 1. By means of this, the fuel assembly 3 is maintained with upright posture in the reactor core.

It is necessary to maintain the adjacent fuel assemblies 3 separated from each other by a proper distance so that the + shaped control rod 2 can be moved vertically through gaps formed between four fuel assemblies 3. For this purpose, in the neighborhood of the upper end portion of the channel box 4, a channel fastener 6 is installed on the center side of the grid, and a channel spacer 7 is installed on the outside of the grid. The channel fastener 6 is provided with a leaf spring 8. By the elastic force of the leaf spring 8, the adjacent fuel assemblies 3 are directed in the mutually separated direction. By means of this, the fuel assemblies 3 are pressed horizontally on the wall of the upper grid plate 1 so that the gaps between adjacent fuel assemblies 3 are maintained properly. Additionally, even if vibration occurs in the reactor core during operation of the reactor, the vibration can be absorbed by the elastic force of the leaf spring 8.

FIG. 2 is a perspective view showing a conventional channel fastener. FIG. 3 is a side view showing the conventional channel fastener. This channel fastener 6 comprises a leaf spring 8, a leaf spring guard 9, a fixing screw 10 and a lock washer 11. The leaf spring guard 9 includes a leaf spring guard flat upper plate 12 which is extended horizontally and has a shape of roughly right-angled triangle, and a leaf spring guard leg body 13 which is extended vertically downward from the edge portion of the leaf spring guard flat upper plate 12 and has a roughly L-shaped horizontal cross section. The leaf spring guard leg body 13 has two face parts that cross each other substantially vertically, and on each face part is formed a stepped part 14 extended from the lateral edge to the bottom edge thereof to protect the leaf spring 8.

The leaf spring 8 formed by bending includes an upper plate part 15 extended horizontally, a bent part 16 connected to the upper plate part 15, and two leaf spring legs 17 connected to the bent part 16 and extended vertically downward. Each leaf spring leg 17 is extended downward along each face part of the leaf spring guard leg body 13 that crosses each other substantially vertically. A leaf spring flat part 18 formed near the center of the leaf spring leg 17 is formed so as to project beyond the height of the stepped part 14 formed on the leaf spring guard leg body 13. The fuel assemblies 3 are maintained in a separated relation to each other by the elastic force generated by mutual contact between the leaf spring flat parts 18 of the channel fasteners 6 mounted respectively on the adjacent fuel assemblies 3. Additionally, the bottom end portions 19 of the leaf spring legs 17 are not fixed but are slidably supported respectively on the face parts of the leaf spring guard leg body 13 that, cross each other substantially vertically.

The channel fastener 6 is fixed on the fuel assembly 3 by fastening the fixing screw 10 to a top tie plate of the fuel assembly 3 through the lock washer 11, a hole formed on the leaf spring 8, a hole formed on the leaf spring guard 9 and a hole formed on the channel box 4.

During the periodical inspection of the reactor, works for changing layout of fuel assemblies are executed. For the works for changing layout, a fuel exchanger is used for hooking or gripping the handle of the fuel assembly. The fuel exchanger is used to lift the fuel assembly and hang it to another position before it is inserted.

During the work for changing layout of fuel assemblies, the leaf spring may be deformed due to the movement of the fuel assembly. FIG. 4 is a view showing the deformation process of the leaf spring of the channel fastener. FIG. 4(a) shows a channel fastener before deformation. When a fuel assembly is hung and inserted into a predetermined location, the bottom portion (bottom tie plate, etc.) of the fuel assembly to be inserted may come into contact with the channel fastener 6 of the adjacent fuel assembly already loaded. Especially, as shown in FIG. 4(b), if the bottom of the fuel assembly contacts with the edge portion 15a located near the bent part 16 in the upper plate 15 of the leaf spring 8 so that external force is applied to the leaf spring 8, the leaf spring leg 17 of the leaf spring 8 may be deformed laterally to cause unwanted plastic deformation in the leaf spring 8. When large plastic deformation happens in the leaf spring 8, the leaf spring leg 17 may go over the spring guard peak part 20 formed in the crossing portion of the face parts of the leaf spring guard leg body 13.

If the plastic deformation happens in the leaf spring 8 to the extent that the bottom end portion 19 of the leaf spring leg 17 is projected over the leaf spring guard peak part 20, at the next periodic inspection, when a fuel assembly provided with a channel fastener having the plastic deformation is hung down to be inserted into the predetermined location, the bottom end portion 19 of the leaf spring leg 17 may be caught by a jig. etc. used for work for changing layout of the fuel assemblies, as shown in FIG. 4(c). In this condition, if the fuel assembly is lowered as it is, the leaf spring leg 17 may be curled up. This could cause interference with another fuel assembly or machinery such as a jig so as to obstruct the work.

A channel fastener with a notch formed at the bottom end corner of the leaf spring guard is disclosed in Japanese Patent Laid-Open No. H8-54485. By forming the notch at the bottom end of the leaf spring guard, the bottom of the channel fastener is not caught by obstacles when the fuel assembly 3 is loaded, so it is possible to prevent damage to the channel fastener beforehand.

A channel fastener, in which a protrusion that is engaged with the leaf spring guard near the bottom end of the leaf spring guard is formed, is disclosed in Japanese Patent Laid-Open No. H5-72366. Because the protrusion engaged with the leaf spring guard is formed, the displacement of the leaf spring guard is constrained. Thereby, even if a channel fastener set screw is loosened by any action, the sway of the channel fastener is prevented.

Patent Document 1: Japanese Patent Laid-Open No. H8-54485

Patent Document 2: Japanese Patent Laid-Open No. H5-72366

### DETAILED DESCRIPTION OF THE INVENTION

### (Problem to be Solved by the Invention)

The channel fasteners described in the above documents can

prevent another fuel assembly or machinery such as a jig from contacting with the leaf spring guard. However, as the prevention of the plastic deformation of the leaf spring was not considered from the beginning, the plastic deformation of the leaf spring can not be prevented. The leaf spring with plastic deformation, as shown in FIGS. 4(b) and 4(c) needs to be exchanged. However, from the standpoint of radioactive protection, the exchange work should be done by underwater remote control, so it has a problem that it needs a lot of work processes and work time.

The present invention was made to solve the above problems. The object of the present invention is to provide a channel fastener capable of preventing or suppressing the plastic deformation of the leaf spring and also preventing additional plastic deformation caused by the relevant plastic deformation even if the plastic deformation happens in the leaf spring. In particular, the object of the present invention is to provide a channel fastener which can prevent the plastic deformation of the leaf spring even in the case that another fuel assembly or machinery such as a jig, etc. contacts therewith from the upper side during works for hanging down the fuel assembly, etc.

### (Technical Solution)

To achieve the above objects, there is provided a channel fastener according to the present invention comprising: a leaf spring guard having a leg body formed in a roughly L-shape in horizontal cross section and extended vertically, and a flat upper plate connected, to the leg body at the upper end of the leg body and extended horizontally; and a leaf spring having an upper plate part fixed to the leaf spring guard flat upper plate and extended along the leaf spring guard flat upper plate, and at least two legs connected to the upper plate part and extended downward along the leaf spring guard leg body, wherein one or a plurality of projected parts are formed on the leaf spring guard flat upper plate.

By means of this, as the projected part is formed on the leaf spring guard flat upper plate, a fuel assembly, etc. can be prevented or suppressed from contacting with the leaf spring upper plate part when a fuel assembly, etc. contacts with the channel fastener. Therefore, there is an effect of preventing or suppressing the plastic deformation of the leaf spring.

According to the channel fastener of the present invention, the projected part is extended upward to the height as high as the leaf spring upper plate part, or projected upward beyond the leaf spring upper plate part.

By means of this, even if the fuel assembly, etc. contacts with the channel fastener from the upper side, the fuel assembly, etc. contacts with the projected part before the fuel assembly, etc. contacts with the leaf spring upper plate part. Therefore, there is an effect of preventing the plastic deformation of the leaf spring.

According to the channel fastener of the present invention, the projected part is formed on the edge portion of the leaf spring guard flat upper plate.

By means of this, the leaf spring does not interfere with the projected part formed on the leaf spring guard flat upper plate. Therefore, it is almost unnecessary to change the shape of the leaf spring guard and there is an effect of manufacturing channel fasteners easily.

According to the channel fastener of the present invention, the gap between the leaf spring guard and the leaf spring is substantially eliminated in the neighborhood area where the leaf spring guard shoulder part connected to the leaf spring guard flat upper plate and the leaf spring bent part connected to the leaf spring upper plate part contact each other.

By means of this, even if the fuel assembly, etc. contacts with the leaf spring upper plate part from the upper side, the leaf spring upper plate part is supported by the leaf spring guard from the lower side. Therefore, there is an effect of preventing or suppressing the generation of the plastic deformation in the leaf spring.

According to the channel fastener of the present invention, a suppressing part for suppressing the bottom end portion of the leaf spring leg from being displaced in the direction of a leaf spring guard peak part is formed on the peak part formed in the crossing portion of the face parts of the leaf spring guard leg body that cross each other substantially vertically.

By means of this, even if the fuel assembly, etc. contacts with the leaf spring upper plate part from the upper side to cause the plastic deformation in the leaf spring, the bottom end portion of the leaf spring leg is suppressed from being deformed in the direction of the peak part of the leaf spring guard. Therefore, there is an effect of preventing the leaf spring from interfering with another fuel assembly or machinery such as a jig.

According to the channel fastener of the present invention, a projected part projected upward beyond the leaf spring upper plate part is formed on the edge portion of the leaf spring guard flat upper plate, and the suppressing part is extended upward along the leaf spring guard peak part and has a projected part projected upward beyond the leaf spring upper plate part.

By means of this, even if the fuel assembly, etc. contacts with the channel fastener from the upper side, the fuel assembly, etc. contacts with either one or both of the projected parts, which are formed on the leaf spring guard flat upper plate and the suppressing part, before the fuel assembly, etc. contacts with the leaf spring upper plate part. Therefore, there is an effect of preventing the plastic deformation of the leaf spring.

According to the channel fastener of the present invention, a protective member is mounted so as to cover at least the leaf spring upper plate part and the leaf spring bent part.

By means of this, even if the fuel assembly, etc. contacts with the channel fastener from the upper side, the fuel assembly, etc. does not directly contact with the leaf spring by contacting with the protective member. Therefore, there is an effect of preventing or suppressing the plastic deformation of the leaf spring.

According to the channel fastener of the present invention, the protective member is formed so as to function also as a lock washer.

By means of this, there is an effect of preventing the increase in the number of components of the channel fastener in the reactor that needs strict supervision of loss of components.

According to the channel fastener of the present invention, an inwardly dragged-retreated part is formed on at least one corner part facing the leaf spring guard peak part among the corner parts formed on both sides of the bottom end portion of the leaf spring leg.

By means of this, even if another fuel assembly or machinery such as a jig, etc. contacts with the retreated parts when a fuel assembly provided with a plastically deformed leaf spring is lowered, the leaf spring leg is displaced laterally. Therefore, there is an effect of preventing the leaf spring from being curled up.

According to the channel fastener of the present invention, the retreated part is formed in a circular arc form.

By means of this, it is possible to make the width of the contact portion larger near the bottom end portion of the leaf spring leg that contacts with the face parts of the leaf spring guard that cross each other substantially vertically, compared with the case that the corner part is cut slantly. Therefore, there is an effect of maintaining the larger elastic force of the leaf spring,

### BRIEF DESCRIPTION OF THE DRAWINGS

These and other features, aspects and advantages of preferred embodiments of the present invention will be more fully described in the following detailed description, taken in conjunction with the accompanying drawings. In the drawings:

FIG. 1 is an illustration showing the schematic overview of a fuel assembly loaded in the reactor core of a boiling water reactor;

FIG. 2 is a perspective view showing the conventional channel fastener;

FIG. 3 is a side view showing the conventional channel fastener;

FIG. 4 is a view showing the deformation process of the leaf spring of the channel fastener:

FIG. 5 is a perspective view showing an example of configuration of a channel fastener according to a first embodiment of the present invention;

FIG. 6 is a side view showing the example of configuration of the channel fastener according to the first embodiment of the present invention:

FIG. 7 is a side view showing an example of configuration of a channel fastener according to a second embodiment of the present invention:

FIG. 8 is a perspective view showing an example of configuration of a channel fastener according to a third embodiment of the present invention;

FIG. 9 is a perspective view showing another example of configuration of the channel fastener according the third embodiment of the present invention;

FIG. 10 is a perspective view showing an example of configuration of a channel fastener according to a fourth embodiment of the present invention;

FIG. 11 is a perspective view showing an example of configuration of a channel fastener according to a fifth embodiment of the present invention: and

FIG. 12 is a perspective view showing another example of configuration of the channel fastener according to the fifth embodiment of the present invention.

### EXPLANATION OF REFERENCE NUMERALS

1 upper grid plate, 2 control rod, 3 fuel assembly, 4 channel box, 5 fuel support metal fitting, 6 channel fastener, 7 channel spacer, 8 leaf spring, 9 leaf spring guard, 10 fixing screw, 11 lock washer, 12 leaf spring guard flat upper plate, 13 leaf spring guard leg body, 14 stepped part, 15

leaf spring upper plate part, 16 leaf spring bent part, 17 leaf spring leg, 18 leaf spring fiat part, 19 leaf spring bottom end portion, 20 leaf spring guard peak part, 21 and 26 projected part, 22 stepped part, 23 gap, 24 leaf spring guard shoulder part, 25 deformation suppressing part, 27 protective member, 28 corner part, 29 and 30 retreated part

### BEST MODE FOR CARRYING OUT THE INVENTION

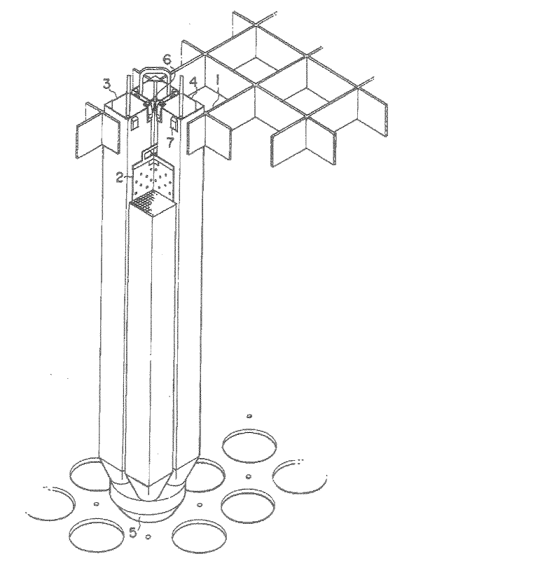

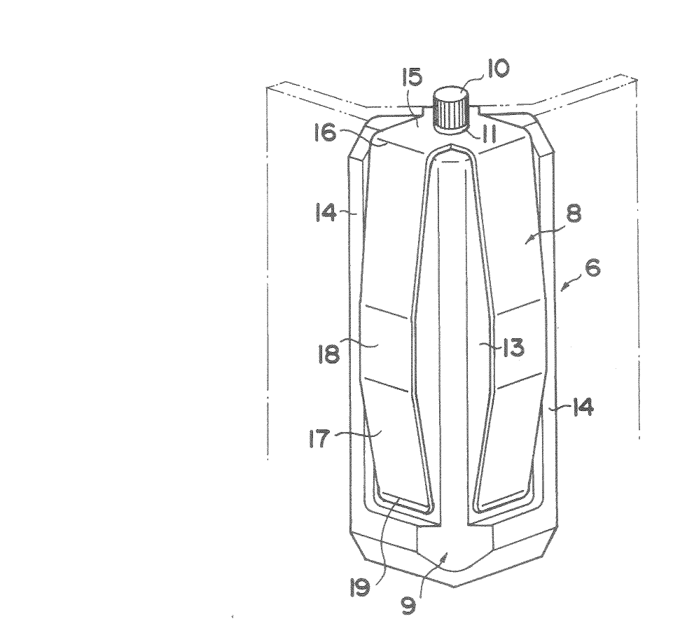

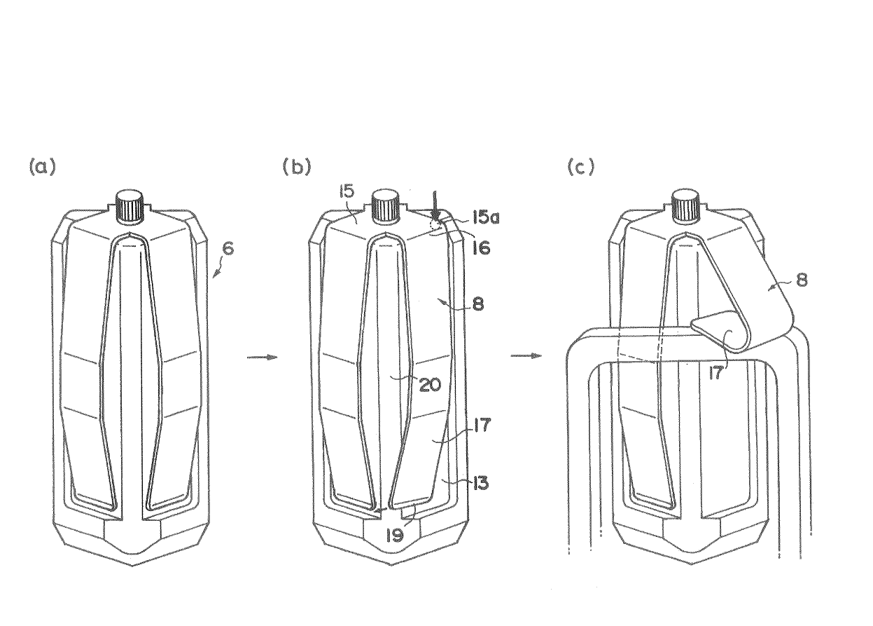

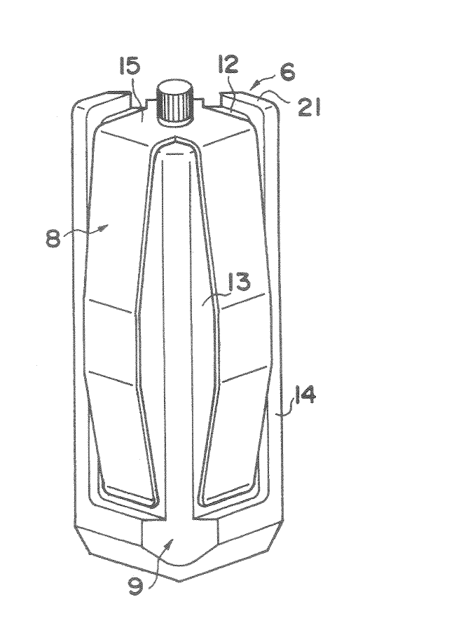

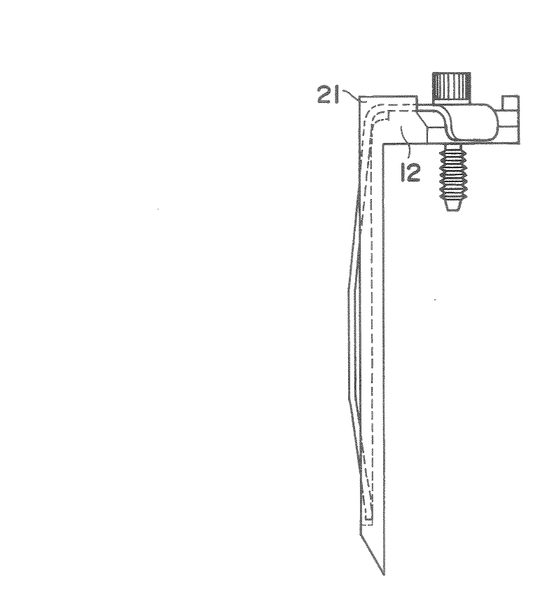

FIG. 5 is a perspective view showing an example of configuration of a channel fastener according to a first embodiment of the present invention. FIG. 6 is a side view showing the example of configuration of the channel fastener according to the first embodiment of the present invention. In the description below, the components that are the same as those described for the channel fastener shown in FIGS. 1 to 4 are given the same reference numerals and description about them will be omitted. The leaf spring guard fiat upper plate 12 is provided with projected parts 21 formed in the portions that are not in contact with the leaf spring 8 such as edge portions. These projected parts 21 are formed so as to be extended upward to the height same as the top surface portion of the leaf spring upper plate part 15, or extended beyond the top surface portion. FIGS. 5 and 6 show a configuration in which the stepped part 14 formed on the edge portion of the leg body 13 of the leaf spring guard 9 is extended upward so as to form the stepped part 14 and the projected parts 21 monolithically. By forming the projected parts 21 like above, even if the fuel assembly, etc. contacts with the channel fastener 6 from the upper side, the fuel assembly, etc. contacts with the projected parts 21 before the fuel assembly, etc, contacts with the leaf spring upper plate part 15. Therefore, it becomes possible to prevent the plastic deformation of the leaf spring 8. Additionally, it may be configured so as to form one or more than one projected parts 21 that do not have a height beyond the leaf spring upper plate 15. That is, the fuel assembly, etc. contacts with the channel fastener 6 along the inclined direction in many cases, so it is possible to prevent the fuel assembly, etc. from contacting with the leaf spring upper plate part 15, even if the projected parts 21 do not have sufficient height.

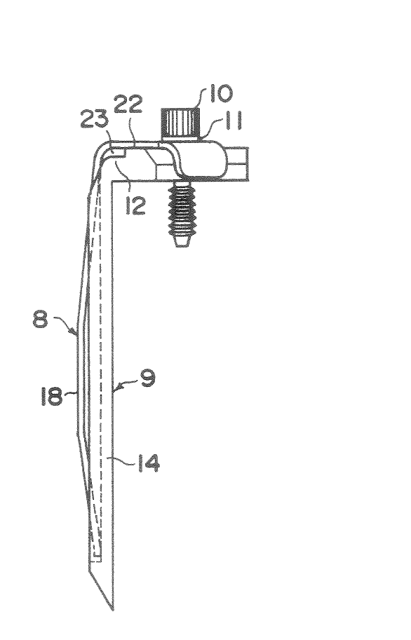

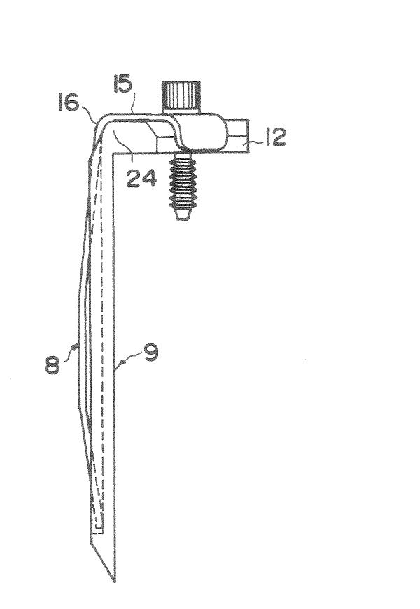

FIG. 7 is a side view showing an example of configuration of a channel fastener according to a second embodiment of the present invention. This channel fastener is characterized by that the gap between the leaf spring 8 and the leaf spring guard 9 is substantially eliminated near the bent part 16 of the leaf spring 8. In the conventional channel fastener as shown in FIG. 3, a stepped part 22 with a gap 23 is formed on the leaf spring guard flat upper plate 12. In contrast to this, in the channel fastener according to this embodiment, the curved surface shape of the bottom surface of the leaf spring upper plate part 15 near the bent part 16 and the curved surface shape of the top surface of the leaf spring guard 9 near the leaf spring guard shoulder part 24 are formed roughly identical, so that the gap does substantially not exist. By eliminating the stepped part on the leaf spring guard flat upper plate 12, the curvature radius of the bottom surface of the leaf spring upper plate part 15 near the bent part 16 and the curvature radius of the top surface of the leaf spring guard 9 near the shoulder part 24 can be made roughly identical. By substantially eliminating the gap between the leaf spring 8 and the leaf spring guard 9, even if the fuel assembly, etc. contacts with the leaf spring upper plate part 15 from the upper side, the leaf spring upper plate part 15 is supported by the leaf spring guard 9 from the lower side. Therefore, it becomes possible to prevent or suppress the plastic deformation of the leaf spring 8.

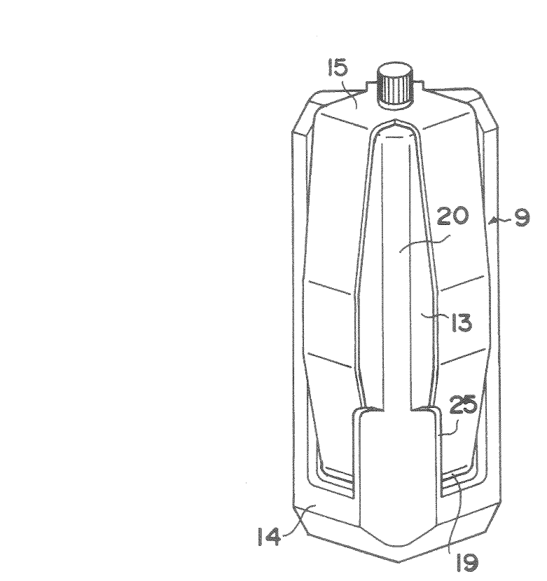

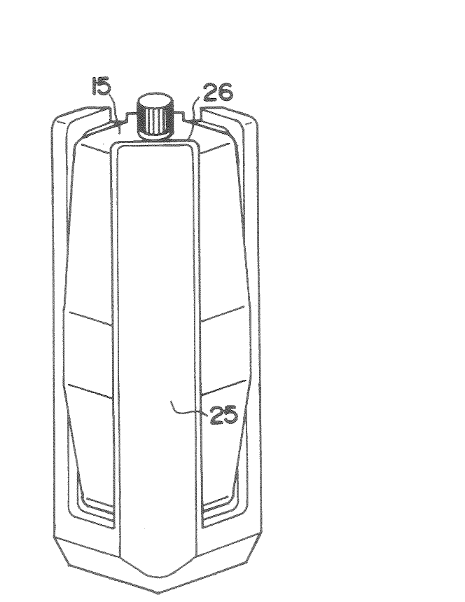

FIG. 8 is a perspective view showing an example of configuration of a channel fastener according to a third embodiment of the present invention. FIG. 9 is a perspective view showing another example of configuration of the channel fastener according to the third embodiment of the present invention. On the peak part 20 formed on the leg body 13 of the leaf spring guard 9 is formed a deformation suppressing part 25 expanded from the leaf spring guard peak part 20. In the example of configuration of this embodiment illustrated in FIG. 8, the deformation suppressing part 25 expanded from the lower portion of the leaf spring guard peak part 20 is formed so as to be made into one unit with the stepped part 14 formed on the lower edge portion of the face parts of the leaf spring guard 9 that cross each other substantially vertically. By forming a deformation suppressing part 25 like above, it becomes possible to prevent or suppress the bottom end portion 19 of the leaf spring leg 17 from being displaced in the direction of the leaf spring guard peak part 20, even if the leaf spring 8 is plastically deformed by the fuel assembly, etc. contacting with the leaf spring upper plate part 15 from the upper side.

In another example of configuration of this embodiment shown in FIG. 9, the deformation suppressing part 25 is formed so as to be extended upward beyond the top surface portion of the leaf spring upper plate part 15. A projected part 26 near the top end portion of the deformation suppressing part 25 has the function identical with the projected parts 21 in the configuration of the first embodiment. That is, even if the fuel assembly, etc. contacts with the channel fastener 6 from the upper side, the fuel assembly, etc. contacts with the projected parts 21 or the projected part 26 before the fuel assembly, etc. contacts with the leaf spring upper plate part 15. Therefore, it becomes possible to prevent the plastic deformation of the leaf spring 8. In addition, even if the leaf spring 8 is plastically deformed for any reason, it becomes possible to prevent or suppress the bottom end portion 19 of the leaf spring leg 17 from being displaced in the direction of the leaf spring guard peak part 20 by the deformation suppressing part 25.

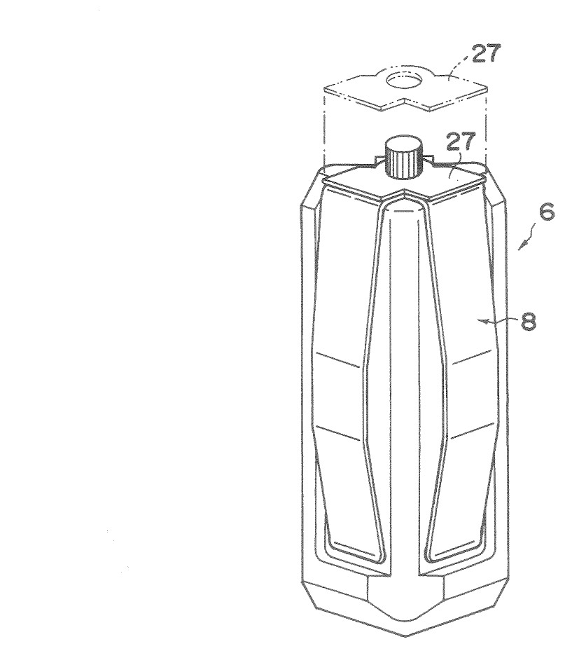

FIG. 10 is a perspective view showing an example of configuration of a channel fastener according to a fourth embodiment of the present invention. On the top side of the leaf spring upper plate part 15 is mounted a protective member 27 that covers the leaf spring bent part 16 as well. By mounting the protective member 27 that covers the leaf spring bent part 16 as well, even if the fuel assembly, etc. contacts with the channel fastener 6 from the upper side, the fuel assembly, etc. contacts with the protective member 27 so that the fuel assembly, etc. does not contact with the leaf spring 8 directly. By means of this, it becomes possible to prevent or suppress the plastic deformation of the leaf spring 8. Additionally, the protective member 27 that covers the bent part 16 as well may be configured so as to also have the function of a lock washer 11. In the reactor for which it is necessary to strictly supervise the loss of components, it becomes possible to prevent the increase in the number of components of the channel fastener by making the protective member 27 and the lock washer 11 into one unit. Additionally, even if the protective member 27 and the lock washer 11 are mounted separately, instead of making them into one unit, the effect of suppressing the plastic deformation of the leaf spring is the same.

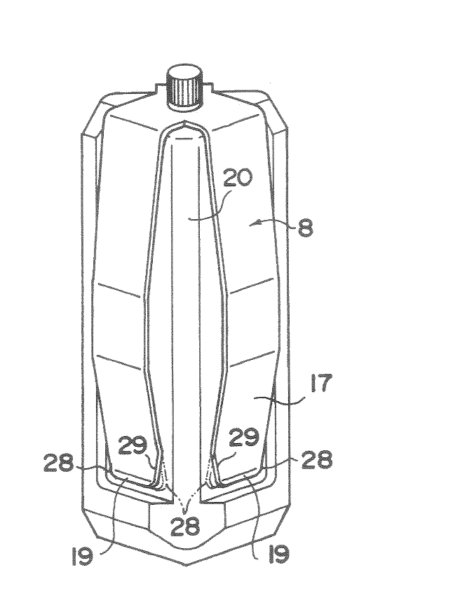

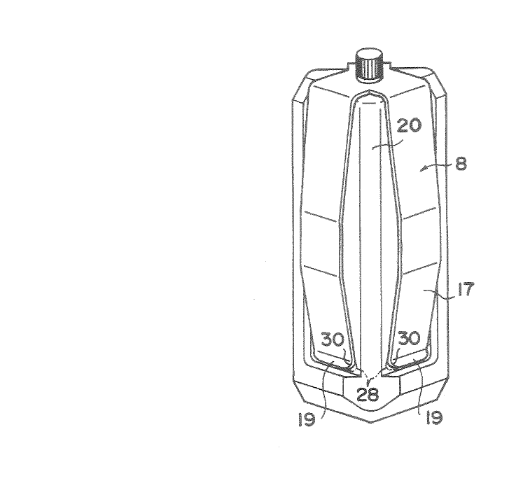

FIG. 11 is a perspective view showing an example of configuration of a channel fastener according to a fifth embodiment of the present invention. FIG. 12 is a perspective view showing another example of configuration of the channel fastener according to the fifth embodiment of the present invention. Among the corner parts 28 of the bottom end portion 19 of each leaf spring leg 17 composing the leaf spring 8, at least one corner part 28 facing the leaf spring guard peak part 20 has a retreated part 29 formed in an inwardly dragged shape. In the example of configuration of this embodiment shown in FIG. 11, the retreated part 29 is formed by slantly cutting the corner part 28 facing the leaf spring guard peak part 20, in the neighborhood of the bottom end portion 19 of each leaf spring leg 17. Even if the leaf spring 8 is plastically deformed and the leaf spring leg 17 is displaced in the direction of the leaf spring guard peak part 20, the force applied from machinery such as another fuel assembly, or a jig, etc. acts in the lateral direction when the machinery contacts with the retreated parts 29 from the lower side. Consequently, the leaf spring leg 17 moves in the direction of returning to the original position. That is, when a fuel assembly 3 provided with a plastically deformed leaf spring 8 is lowered, even if machinery such as another fuel assembly, or a jig, etc. contacts with retreated parts 29, the leaf spring leg 17 moves in the lateral direction. Therefore, it is possible to prevent the leaf spring 8 from being curled up.

In another example of this embodiment illustrated in FIG. 12, circular arc shaped retreated parts 30 are formed on the side facing the leaf spring guard peak part 20, in the neighborhood of the bottom end portion 19 of the leaf spring leg 17. In this case, the force from machinery such as another fuel assembly, or jig, etc. also acts in the lateral direction when the machinery contacts with the retreated parts 30 from the lower side. Consequently, the leaf spring leg 17 moves in the direction of returning to the original position. Therefore, it becomes possible to prevent the leaf spring 8 from being curled up. Additionally, as the curvature radius of the retreated part 30 is larger, it becomes easier for the machinery to contact with the retreated part 30 without contacting with the bottom end portion 19, so it becomes more possible to prevent the leaf spring from being curled up. Further, by forming a circular arc shaped retreated part 30 instead of forming an inclined retreated part 29, it is possible to make the width of the contact portion larger near the bottom end portion of the leaf spring leg 17 which contacts with the face parts of the leaf spring guard 9 that cross each other substantially vertically. Therefore, it is possible to maintain the larger elastic force of the leaf spring 8, compared with the case of the corner part being slantly cut.

Additionally, the channel fasteners described by the aforementioned first to fifth embodiments are not to limit the present invention and are disclosed with the intention for illustrations. The scope of the present invention is determined by description of claims, and various design changes are possible within the technical scope of the present invention. For instance, the configuration in which the gap between the leaf spring 8 and the leaf spring guard 9 is substantially eliminated according to the second embodiment may be applied by combining it to a channel fastener shown according to another embodiment of the present invention. By means of this, it becomes possible to prevent or suppress the plastic deformation of the leaf spring 8 more effectively.

What is claimed is:

1. A channel fastener comprising:
a leaf spring guard having a leg body formed in a roughly L-shape in horizontal cross section and extended vertically, and a flat upper plate connected to said leg body at the upper end of said leg body and extended horizontally; and
a leaf spring having an upper plate part fixed to said leaf spring guard flat upper plate and extended along said leaf spring guard flat upper plate, and at least two legs connected to said upper plate part and extended downward along said leaf spring guard leg body,
wherein one or a plurality of projected parts are formed on said leaf spring guard flat upper plate.

2. The channel fastener according to claim 1, wherein said projected part is extended upward to the height as high as said leaf spring upper plate part, or projected upward beyond said leaf spring upper plate part.

3. The channel fastener according to claim 1, wherein said projected part is formed on the edge portion of said leaf spring guard flat upper plate.

4. A channel fastener comprising:
a leaf spring guard having a leg body formed in a roughly L-shape in horizontal cross section and extended vertically, a shoulder part connected to said leg body at the upper end of said leg body, and a flat upper plate connected to said shoulder part and extended horizontally; and
a leaf spring having an upper plate part fixed to said leaf spring guard flat upper plate and extended along said leaf spring guard flat upper plate, a bent part bent near said leaf spring guard shoulder part and connected to said upper plate part, and at least two legs connected to said bent part and extended downward along said leaf spring guard leg body,
wherein the gap between said leaf spring guard and said leaf spring is substantially eliminated in the neighborhood area where said leaf spring guard shoulder part and said leaf spring bent part contact each other.

5. A channel fastener comprising:
a leaf spring guard having a leg body formed in a roughly L-shape in horizontal cross section and extended vertically, and a flat upper plate connected to said leg body at the upper end of said leg body and extended horizontally; and
a leaf spring having an upper plate part fixed to said leaf spring guard flat upper plate and extended along said leaf spring guard flat upper plate, and at least two legs connected to said upper plate part and extended downward along said leaf spring guard leg body,
wherein a suppressing part for suppressing the bottom end portion of said leaf spring leg from being displaced in the direction of a leaf spring guard peak part is formed in said peak part formed on the crossing portion of the face parts of said leaf spring guard leg body that cross each other substantially vertically.

6. The channel fastener according to claim 5, wherein a projected part projected upward beyond said leaf spring upper plate part is formed on the edge portion of said leaf spring guard flat upper plate, and
said suppressing part is extended upward along said leaf spring guard peak part and has a projected part projected upward beyond said leaf spring upper plate part.

7. A channel fastener comprising:
a leaf spring guard having a leg body formed in a roughly L-shape in horizontal cross section and extended vertically, a shoulder part connected to said leg body at the upper end of said leg body, and a flat upper plate connected to said shoulder part and extended horizontally; and
a leaf spring having an upper plate part fixed to said leaf spring guard flat upper plate and extended along said leaf spring guard flat upper plate, a bent part bent near said leaf spring guard shoulder part and connected to said upper plate part, and at least two legs connected to said bent part and extended downward along said leaf spring guard leg body,
wherein a protective member is mounted so as to cover at least said leaf spring upper plate part and said leaf spring bent part.

8. The channel fastener according to claim 7, wherein
said protective member is formed so as to function also as a lock washer.

9. A channel fastener comprising:
a leaf spring guard having a leg body formed in a roughly L-shape in horizontal cross section and extended vertically, and a flat upper plate connected to said leg body at the upper end of said leg body and extended horizontally, wherein a peak part is formed on the crossing portion of the face parts of said leg body that cross each other substantially vertically; and
a leaf spring having an upper plate part fixed to said leaf spring guard flat upper plate and extended along said leaf spring guard fiat upper plate, and at least two legs connected to said upper plate part and extended downward along said leaf spring guard leg body,
wherein, an inwardly dragged-retreated part is formed on at least one corner part facing said leaf spring guard peak part among the corner parts formed on both sides of the bottom end portion of said leaf spring leg.

10. The channel fastener according to claim 9, wherein said retreated part is formed in a circular arc form.
